(19) United States
(12) Patent Application Publication
(10) Pub. No.: US 2002/0092694 A1
(43) Pub. Date: Jul. 18, 2002

(54) Loader vehicle with pivoting console panel

(76) Inventor: Douglas William McIlwraith, Burleigh Heads (AU)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/096,997

(22) Filed: Mar. 13, 2002

Related U.S. Application Data
(62) Division of application No. 09/470,331, filed on Dec. 22, 1999.

(30) Foreign Application Priority Data
Dec. 23, 1998 (AT) PP7865

(51) Int. Cl. B60K 26/00

(52) U.S. Cl. 180/315

(57) ABSTRACT

A skid-steer mini-loader (10) has a compact chassis formed by two side walls (11,12) fixed to either side of a tank (13) which forms an oil reservoir for a hydraulic drive system for the mini-loader. A hydraulic pump (30) is located within the tank (13), and is driven by an engine (31) mounted directly on top of the tank. A console panel (19) having controls (20) thereon forms the rear wall and top of a cover for the power plant. The console panel is pivotally mounted at its lower end to the chassis, enabling the panel (19) to be opened out and thereby facilitate access to the power plant.

THIS INVENTION relates to improvements in loader vehicles. In particular, the invention is directed to a skid-steer mini-loader having a pivoting console panel.

This application is a divisional application in respect of my copending U.S. patent application no. 09/470331.

### BACKGROUND ART

There are various types of known skid-steer loaders, perhaps the most popular being that sold under the trade mark BOBCAT™. The popularity of these loaders is due, at least in part, to their manoeuverability and versatility. The hydraulic skid-steer drive enables the loader to turn sharply, and eliminates the need for complex steering and gearing mechanisms. The interchangeability of the loader bucket with other tools, such as a posthole digger, trench digger, rotary sweeper, etc. enables a single machine to provide a variety of functions.

In recent years, a smaller, stand-on version of the skid-steer loader has become popular for lighter tasks and/or operation in confined places. These smaller loaders are commonly known as “mini-loaders”. Examples of mini-loaders, sold under the trade marks KANGA™ (in the U.S.) and JADEN™ (in Australia), are illustrated in U.S. Design Pat. Nos. 359,497 and 431,574.

These known mini-loaders are operated by an operator standing on a platform at the rear of the machine, and using control levers mounted at waist height on a fixed frame in front of the operator. This fixed frame restricts access to the power plant mounted on the chassis under the frame, thereby making it difficult or awkward to remove or access the power plant for servicing.

This invention relates to an improved loader vehicle, and in particular, to a skid-steer mini-loader having a pivoting console panel which facilitates access to the power plant.

### SUMMARY OF THE INVENTION

The invention provides a small loader, such as a skid-steer mini-loader, which has a chassis, and a power plant mounted on the chassis. A console panel, having controls mounted thereon for operation of the loader, has its lower end pivotally mounted to the chassis. The console panel is pivotable between a closed position (where it at least partially covers the power plant) to an open position (whereat the power plant is exposed), thereby facilitating access to the power plant.

The panel typically forms the rear wall and top wall of a cover for the power plant.

Typically, the panel pivots rearwardly from its closed position to its open position.

Other features and advantages of the invention will become apparent from the following description of a preferred embodiment of the invention.

### BRIEF DESCRIPTION OF THE DRAWINGS

FIG. 1 is a front perspective view of a mini-loader according to one embodiment of the invention,

FIG. 2 is a side elevation of the mini-loader of FIG. 1,

FIG. 3 is a rear perspective view of the mini-loader of FIG. 1,

FIG. 4 is a side perspective view of the mini-loader of FIG. 1, with console panel opened,

FIG. 5 is a perspective view of the engine and pump mechanism of the mini-loader of FIG. 1,

FIG. 6 is a perspective view of the bucket hitch mechanism of the mini-loader of FIG. 1, and

FIGS. 7 and 8 are side views of the automatic bucket levelling mechanism of the mini-loader of FIG. 1, with the bucket in the lowered and raised positions, respectively.

### DESCRIPTION OF PREFERRED EMBODIMENT

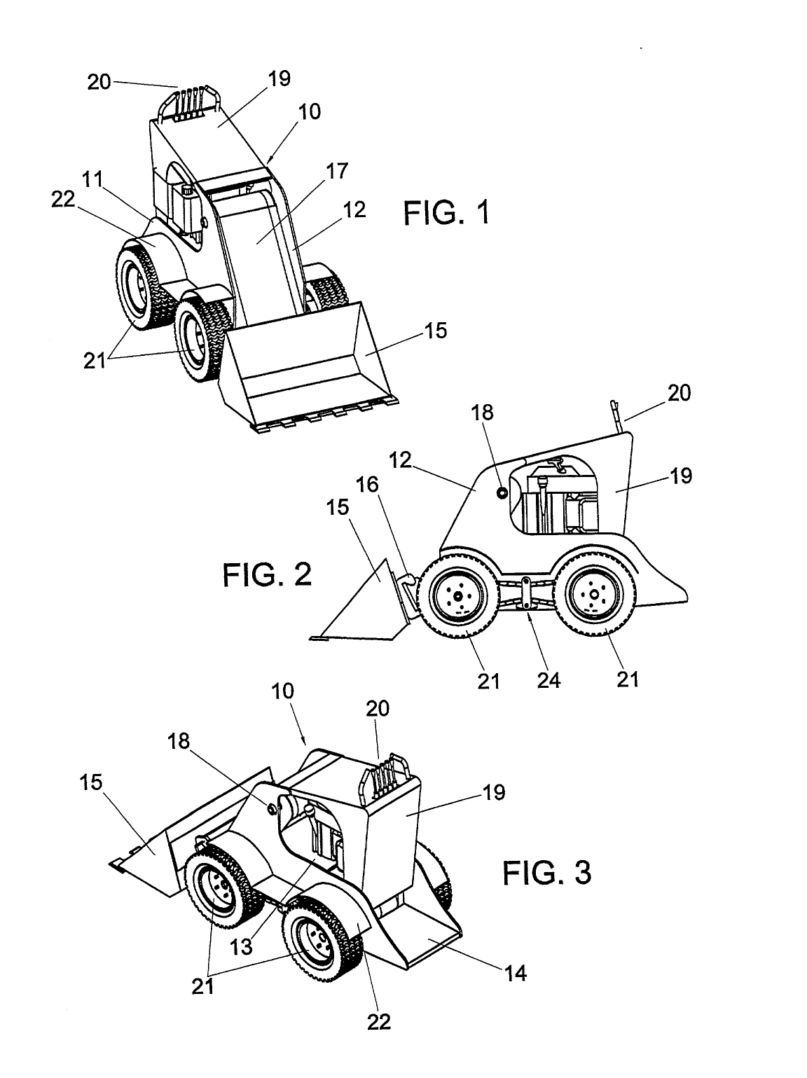

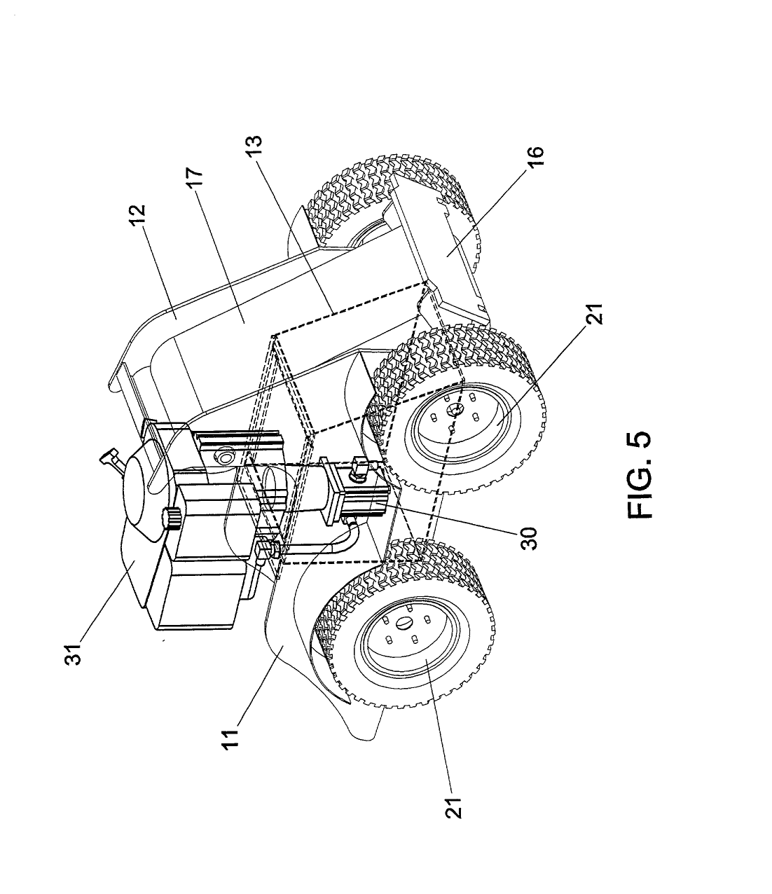

As shown in FIGS. 1-5, a skid-steer vehicle, in the form of a “mini-loader” 10, comprises a chassis formed from two spaced parallel steel plates 11, 12 fixed on either side of a metal tank 13 (shown in dotted outline in FIG. 5). The steel plates 11, 12 may be machine cut and may form the actual sides of the tank. The tank 13 not only serves as an oil reservoir for the hydraulic drive system of the mini-loader, but also forms a box-like structural part of the chassis. This form of construction is relatively simple and economical to manufacture.

A tread plate 14 extends between the rear ends of the side plates 11, 12, as shown in FIG. 3. The tread plate 14 serves as a platform on which the operator stands (and rides) during operation of the mini-loader. Preferably, the tread plate 14 is weighted, to act as a counterbalance to the load carried by a bucket 15 at the front of the mini-loader.

The mini-loader 10 is provided with two pairs of wheels 21. A mudguard 22 may be provided above the wheels 21 on each side of the mini-loader. The mudguards 22 are typically welded, bolted or otherwise fixed to the side walls 11, 12. The mudguards 22 may be used to carry equipment or accessories such as a battery and/or toolbox.

Typically, only one set of wheels is driven hydraulically by the mini-loader power plant. That is, either the front or the rear wheels are driven hydraulically. The driven wheels are each rotated by a hydraulic motor driven by a hydraulic pump via valve(s). Each wheel in the other (non-driven) set of wheels is driven from a respective one of the hydraulically-driven wheels by a chain 24. In this manner, the wheels on each side of the mini-loader rotate in unison.

The tank 13 which forms a structural part of the chassis also serves as the oil reservoir for the hydraulic system used to drive the mini-loader. As shown in FIG. 5, the hydraulic pump 30 is located within the reservoir 13. The pump is used to supply hydraulic fluid under pressure to drive the hydraulic motors coupled to the driven set of wheels 21, the hydraulic cylinders which operate the bucket arm, and auxiliary equipment which may be mounted to the mini-loader. The hydraulic pump 30 is itself driven by a motor, typically an internal combustion engine 31, mounted to the top plate of the tank 13. The engine 31 has a vertical drive shaft which extends into the tank 13 to drive the hydraulic pump 30.

The above-described arrangement of engine, pump and oil tank enables the power plant to be constructed in a very compact form. This in turn, allows the size of the mini-loader to be reduced, permitting the mini-loader to be used in confined spaces. In addition, by locating the pump 30 in the tank 13, a separate intake hose is not required for the pump.

The bucket 15 (or other attachment) is removably mounted to a mounting plate 16 by a “quick hitch” locking mechanism described later. The mounting plate 16 is pivotally connected to one end of a bucket arm 17, the other end of which is pivotally mounted on a pivot pin 18 extending between the side walls 11, 12 of the chassis.

The bucket arm 17 is of inverted channel configuration comprising a web and two end walls, the web being wide relative to the end walls. Such configuration provides a neat, aesthetically pleasing appearance since only the large flat web of the bucket arm is visible from the front of the mini-loader. The wide flat web of the channel-shaped bucket arm 17 not only hides the hydraulic hoses and cylinders under the arm, but also protects such hydraulic equipment and the bucket self-levelling mechanism (described below) from dirt and damage.

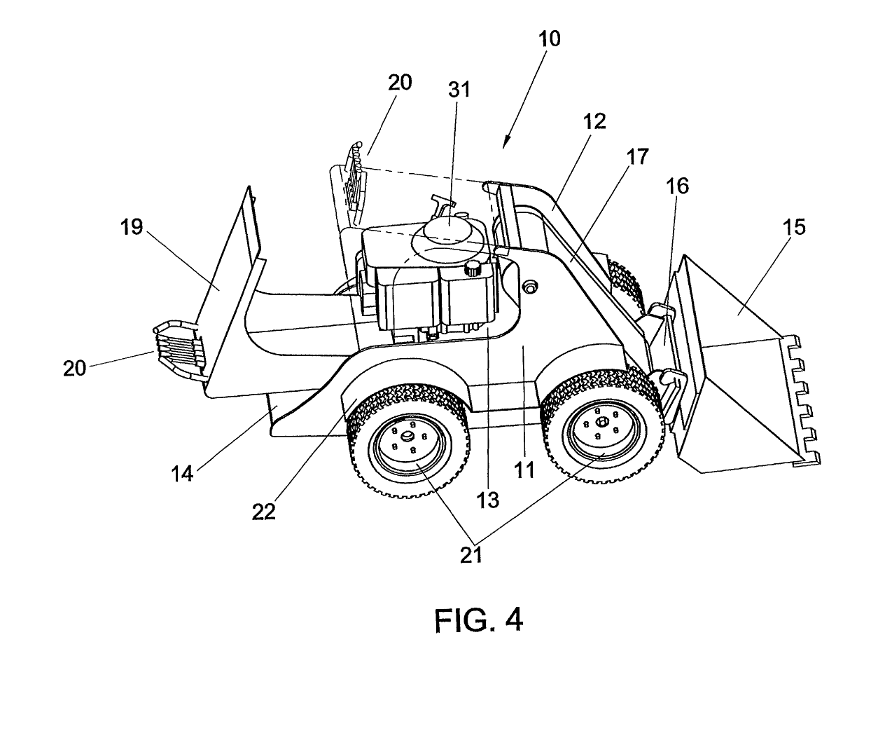

A 7-shaped console panel 19 is located between the side plates 11, 12, as shown in the drawings. The panel 19 forms the rear and top of a cover for the power plant in the engine bay. The lower end of the console panel 19 is pivotally mounted to the side walls 11, 12, enabling the whole console panel 19 to pivot rearwardly (as shown in FIG. 4) and expose the engine bay of the mini-loader.

The engine bay is closed by pivoting the console panel 19 upwardly to the position shown in FIGS. 1-3. At that position, the top forward ends of the control panel 19 can be bolted or otherwise fixed to the side plates 11, 12. Control levers 20 on the console panel are connected to the remainder of the hydraulic operating system by flexible hoses which permit the console panel 19 to be opened and closed.

The ability to pivot the control panel 19 rearwardly and open up the engine bay allows clear access to the engine 31. This facilitates servicing of the engine, as well as the installation and removal of the engine 31 and/or pump 30 from the tank 13. When such access is not required, the console panel can be pivoted upwardly and forwardly to close the engine bay and form a very compact body.

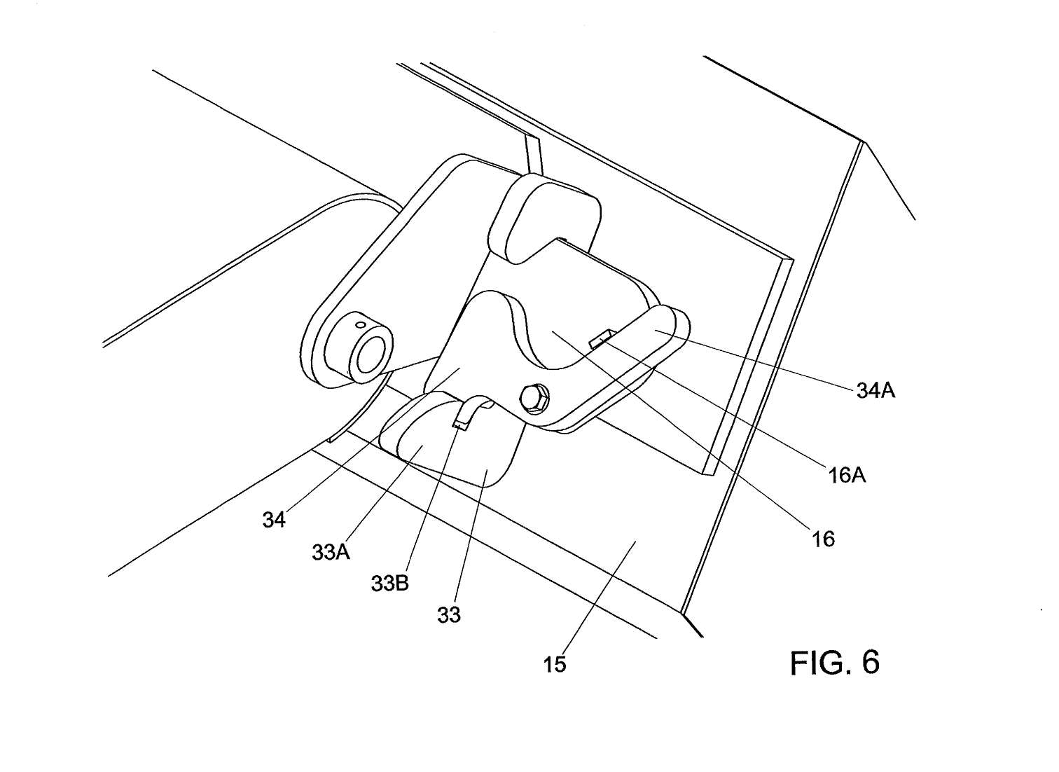

The illustrated mini-loader is provided with a “quick hitch” locking mechanism which enables an operator to mount, and lock, the bucket 15 to the mounting plate 16 without the operator having to dismount from the tread plate 14. As shown in FIG. 6, the bucket 15 is provided with a pair of spaced C-shaped flanges or brackets 33 on the rear thereof. In use, the operator manoeuvers the mounting plate 16 to locate within the C-shaped brackets 33. This can be achieved by inserting the tilted mounting plate 16 into the brackets 33, and then rotating the mounting plate 16 hydraulically.

The mounting plate 16 also comprises a pair of toggle arms 34 pivotally mounted to the rear of the plate 16 at spaced locations corresponding to the mounting brackets 33 of the bucket 15. When the mounting plate 16 is inserted into the C-shaped mounting brackets 33, the toggle arms 34 pivot upwardly as they ride over the nose 33A of the bottom portion of each mounting bracket 33. However, once each toggle arm 34 clears the step at the back of each nose portion, the toggle arm drops down into a slot 33B and securely locks the mounting plate 16 in the mounting brackets 33. It would therefore be apparent that the bucket 15 can be mounted and locked, to the mounting plate 16 by manoeuvering the mounting plate 16 from the operator's console.

To remove the bucket 15 from the mounting plate 16, the outer extension 34A of each toggle arm 34 is kicked down to release the toggle arm from the slot 33B, and the plate 16 is tilted and withdrawn from the brackets.

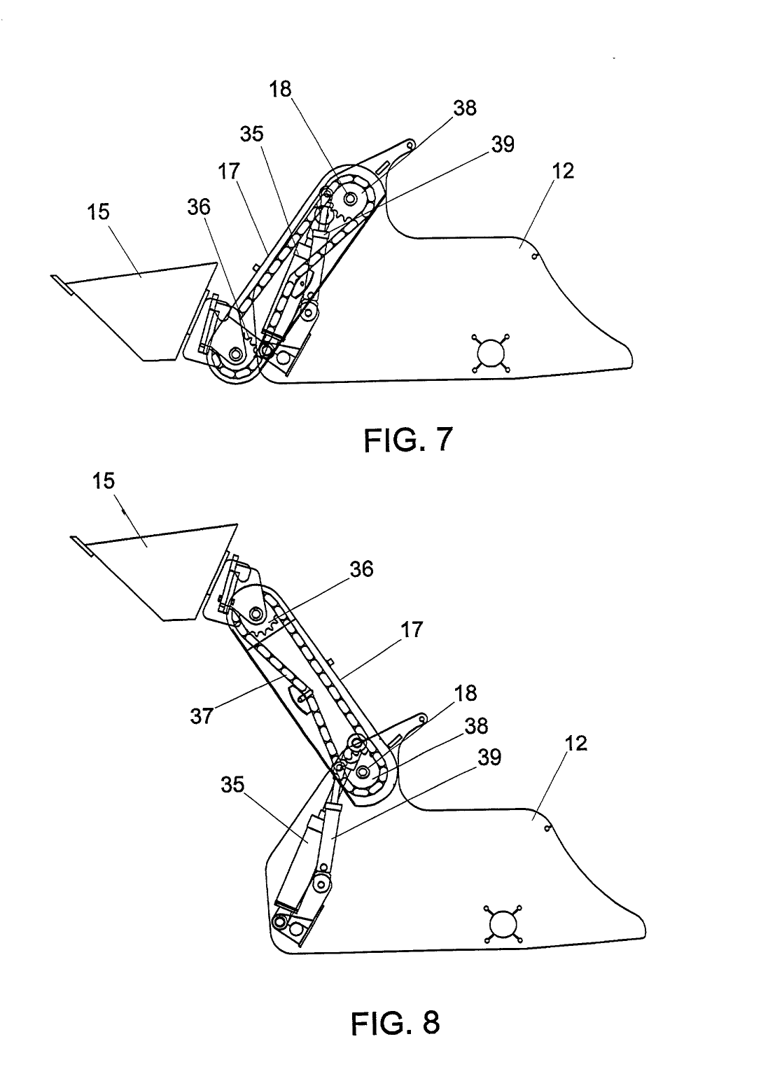

Another advantageous feature of the illustrated mini-loader is an automatic bucket levelling mechanism, depicted schematically in FIGS. 7 and 8. Although bucket levelling mechanisms are known, such mechanisms typically comprise parallelogram linkages and hydraulic cylinders extending upwardly from the bucket arms. In the illustrated bucket levelling mechanism, a chain and sprocket arrangement is used to maintain the bucket at a constant orientation automatically as the bucket arm is raised and lowered.

As shown in FIGS. 7 and 8, the bucket 15 is mounted on the mounting plate 16 at the distal end of the bucket arm 17 whose proximal end is pivotally mounted on the pivot pin 18 extending between the side walls 11, 12. A hydraulic cylinder 35 is mounted between the bucket arm 17 and a transverse bar mounted between lower portions of the side walls 11, 12. The hydraulic cylinder 35 is driven by the hydraulic pump 30 to rotate the bucket arm 17.

A sprocket 36 is fixed to the mounting bracket 16, and is rotatable therewith about the pivot axis of the mounting bracket 16. (The term “rotatable” as used herein also means partially rotatable). An endless chain 37, or similar linkage, connects sprocket 36 with a sprocket 38 mounted on the chassis near the proximal end of arm 17, typically collinear with the pivot axis as arm 17. A hydraulic cylinder 39 is connected between sprocket 38 and a fixed lower point on the chassis of the mini-loader. The cylinder 39 is driven by pump 30, via a control valve on the console panel, to rotate sprocket 38. (In practice, only a small angular rotation is required). As sprockets 36 and 38 are linked by chain 37, any rotation of sprocket 38 causes a corresponding rotation of sprocket 36, thereby causing tilting of the bucket 15 mounted on plate 16. In this manner, hydraulic cylinder 39 is used to vary the orientation of bucket 15.

As the bucket arm 17 is raised and lowered by cylinder 35, and with sprocket 38 fixed in position by cylinder 39, the fixed lengths of chain 37 between sprockets 36, 38 cause rotation of sprocket 36 relative to the arm 17 such that the sprocket 36 maintains a substantially constant orientation relative to (fixed) sprocket 38. The rotation of sprocket 36 compensates for the otherwise opposite rotation of the distal end of arm 17 about the sprocket 38. Thus, the bucket 15 is automatically maintained at a substantially constant orientation as the bucket arm 17 is raised and lowered.

To change the orientation of bucket 15, e.g. to empty the bucket, the cylinder 39 is actuated to rotate sprocket 38, and hence sprocket 36 via the chain linkage.

It will therefore be apparent to those skilled in the art that the abovedescribed chain and sprocket arrangement results in the bucket 15 being self-levelling. That is, the bucket 15 maintains its orientation relative to the horizontal as the arm 17 is raised and lowered (unless sprocket 38 is itself rotated by cylinder 39). Moreover, the chain and sprocket mechanism allows greater angular displacement of the arm 17 and bucket 15 than would otherwise be possible with a rigid parallelogram linkage in the same confined space. The self-levelling mechanism is able to be concealed within the channel-shaped arm 17, and does not detract from the appearance of the mini-loader.

The foregoing describes only one embodiment of the invention, and modifications which are obvious to those skilled in the art may be made thereto without departing from the scope of the invention. For example, the central portions of the chain may be replaced by rigid links.

Furthermore, the improvements disclosed herein such as the self-levelling mechanism, can be applied to other machinery and not only skid-steer vehicles.

The term “comprising” is used in the following claims in the inclusive sense, to mean the stated integers without necessarily excluding other integers.

1. A skid-steer mini-loader having
a chassis,
a power plant mounted on the chassis, and
a panel pivotally mounted at its lower end to the chassis, the panel forming a rear wall and a top wall of a cover for the power plant when the panel is in a closed position,
wherein the panel is a console panel having controls mounted thereon for operation of the mini-loader, and the panel is pivotable to an open position to provide access to the power plant.

2. A mini-loader as claimed in claim 1, wherein the chassis includes a pair of side walls, and the panel is located between the side walls, the panel being pivotally mounted to the side walls.

3. A mini-loader as claimed in claim 2, wherein the panel is of angled configuration, and has a forward upper end adapted to be releasably fixed to the side walls.

4. A mini-loader as claimed in claim 2, further having a tread plate extending between the side walls at the rear of the chassis to provide a platform upon which an operator may stand, the controls being located on top of the panel and forward of the tread plate when the panel is in its closed position.

5. A mini-loader as claimed in claim 1, wherein the panel is pivotable rearwardly to the open position.

6. A small loader vehicle having
a power plant, and
a console panel having controls mounted thereon for operating
the vehicle, the console panel being pivotable between a closed
position and an open position,
wherein the console panel at least partially covers the power plant when in its closed position, and the power plant is uncovered when the console panel is in its open position.

7. A loader vehicle as claimed in claim 6, wherein the console panel is of angled configuration and forms a top wall and a rear wall of a cover for the power plant.

8. A loader vehicle as claimed in claim 7, wherein the loader vehicle has a chassis on which the power plant is mounted, the console panel having the lower end of its rear wall pivotally connected to the chassis, the console panel being pivotable rearwardly from its closed position to its open position.

9. A loader vehicle as claimed in claim 8, wherein the console panel has a forward upper end which is releasably connectible to the chassis to retain the console panel in its closed position.

10. A loader vehicle as claimed in claim 8, wherein the vehicle is a skid-steer mini-loader.

11. A loader vehicle as claimed in claim 10, further comprising a platform at the rear of the mini-loader for a standing operator.

12. A loader vehicle as claimed in claim 11, wherein when the console panel is in its closed position, the controls are located on top of the panel and immediately forward of the platform.

13. In a small loader having a chassis and a power plant mounted on the chassis, the improvement comprising a pivoting console panel having controls mounted thereon for operating the loader, the panel being pivotable rearwardly from a closed position to an open position.
